(19) United States
(12) Patent Application Publication
(10) Pub. No.: US 2016/0353338 A1
(43) Pub. Date: Dec. 1, 2016

(54) Wireless Device, Radio Network Node and Methods for Managing Measurement of Reference Signals

(71) Applicant: TELEFONAKTIEBOLAGET LM ERICSSON (PUBL), Stockholm (SE)

(72) Inventors: Badawi Yamine, Beirut (LB); Angelo Centonza, Stockholm (SE); Oumer Teyeb, Solna (SE)

(21) Appl. No.: 15/117,587

(22) PCT Filed: Feb. 14, 2014
(86) PCT No.: PCT/SE2014/050182

§ 371 Date: Aug. 9, 2016

(51) Int. Cl. H04W 36/00; H04W 48/12; H04W 36/32

(52) U.S. Cl. CPC H04W 36/0061; H04W 36/32; H04W 48/12; H04W 84/045

(57) ABSTRACT

A wireless device (120) and a method therein for managing a measurement of a strength of a reference signal as well as a radio network node (110) and a method therein for enabling the wireless device (120) to manage the measurement of the strength of the reference signal are disclosed. The wireless device (120) of a first cell (101) receives, from the radio network node (110), an indication relating to a property associated with an identity of a second cell (102) neighbouring to the first cell (101). The wireless device (120) receives the identity of the second cell (102). Moreover, the wireless device (120) measures the strength of the reference signal identified by the identity of the second cell (102), only when the property indicates that the wireless device (120) is to perform the measurement on the reference signal. Corresponding computer programs and computer program products are also disclosed.

### TECHNICAL FIELD

Embodiments herein relate to wireless communication systems, such as telecommunication systems. A method and a wireless device for managing a measurement of a strength of a reference signal as well as method and a radio network node for enabling the wireless device to manage the measurement of the reference signal are disclosed. Moreover, corresponding computer programs and computer program products are disclosed.

### BACKGROUND

Within a telecommunication system, it is often desired to improve coverage and data rates. One way of achieving this is to deploy so called femto cells in the telecommunication system.

A femto cell, is a sort of a pico Radio Base Stations (RBS) with very low transmit power, e.g. 20 dBm according to Third Generation Partnership Project (3GPP) specifications, and a coverage of few meters, such as 10-15 meters. In 3GPP for Long Term Evolution (LTE), the femto cell is referred to as Home evolved Node B (HeNB) and for Universal Mobile Telecommunications System (UMTS), the femto cell is referred to as Home Node B (HNB).

A purpose of the HeNB is to overcome the poor indoor coverage of macro base stations and to offload the macro from additional traffic load. Without HeNB, an operator has to deploy more macro base stations. But that alternative is very costly, it also creates additional interference, and it is slow to deploy. Not to forget that a User Equipment (UE), located indoors, has to increase its transmit power in order to overcome indoor propagation losses while connected to the macro base station. The increased transmit power would consequently increase power consumption of the user equipment. Disadvantageously, a battery for powering of the user equipment would have to be charged more often due to the increased power consumption.

Therefore, HeNB deployment is useful for subscribers, or users, thanks to avoidance of increased transmit power as well as for the operator thanks to less costly deployment as compared to macro radio base stations. In order to encourage the use of HeNBs, the operator may give the subscribers reduce calls tariff while using the HeNB.

The macro base station, e.g. operating a macro cell, is accessible, i.e. open, to all subscribers. In contrast thereto, access to the HeNB, e.g. operating one or more HeNB cells:
could be open for all subscribers,
could be restricted to some subscribers also called Closed Subscriber Group (CSG), e.g. resident of the property where HeNB is installed, or
could be hybrid, that is used by all users and CSG but maybe giving reduce call tariff for CSG subscribers.

Every HeNB is given a unique Evolved Cell Global Identity (ECGI). However, before reading that ECGI, based on a request by the eNB, a UE performs radio signal measurements on what is called a Physical Cell Identity (PCI) which identifies different LTE cells at the physical layer.

With the deployment of HeNB with CSG access, referred to as HeNB CSG, it is unnecessary for a UE being a member of one particular CSG to perform measurements on every HeNB that it encounters on its path of movement. A reason for this is that most HeNB are HeNB with CSG access. Thus, it is unlikely that the encountered HeNB is one with a CSG that the UE is a member of.

In prior art, as mentioned in US20130084892, whenever HeNB and macro evolved Node B (eNB) use the same frequency, one way of preventing the wireless device from measuring other HeNB CSG than its own HeNB CSG, is to blacklist the PCI used by its own HeNB CSG until it is geographically closed to his own HeNB CSG. According to a method in US20130084892 mentioned directly above, a wireless device obtains a fingerprint of its own HeNB CSG, e.g. its CSG cell. Thereby, the wireless device is able to determine when it is in the proximity of its own HeNB CSG. Thus, allowing the wireless device to measure on the blacklisted PCI when the wireless device is in the proximity of its own HeNB CSG.

Furthermore, US2013109380 discloses a method of operating a radio access network. According to the method neighbour cell information identifying neighbor cells of a source cell and respective neighbour scrambling codes of the neighbour cells are provided. A report may be received from a wireless terminal through the source cell with the report identifying a reported scrambling code of a reported cell and at least one detected scrambling code of at least one detected cell other than the reported cell. One of the neighbour cells may be selected as a target cell based on the reported scrambling code, the at least one detected scrambling code, and the neighbour cell information.

Moreover, US2013084870 discloses a method in a first network node for handling handover of a user equipment from a source cell to a target cell in a communication network. The first network node selects the target cell from neighbour cells based on information of cell size, which target cell will be used for handover the user equipment to.

In a known LTE system, there are only different 504 PCIs available for use. As the number of HeNB and macro eNB cells exceeds 504 cells, the reuse of the same PCI becomes a very likely choice, if not a necessary choice. One way to prevent a UE from measuring CSG cells with the same PCI of an accessible CSG cell is to blacklist the PCI of the accessible CSG cell as soon as the UE moves away from this cell e.g. according the above mentioned document. However, by black-listing the PCI of one CSG HeNB while the UE is driving away from the CSG cell, there is a chance that the UE encounters the same PCI used either by a macro eNB or by another CSG HeNB. As the PCI is blacklisted, the UE will not measure it and as a consequence a handover towards a possibly allowed better, e.g. in terms of signal strength or the like, cell represented by the blacklisted PCI is blocked. A disadvantage may be that the UE may experience a degraded signal quality and maybe a service interruption, or failure, such as a call drop.

Even in cases where the range of Pas of closed access cells is broadcast, i.e. there is a fixed allocation of PCIs, i.e. a range of reserved PCIs, that can be used only for closed access cells, a problem is that it is not possible for the UE to know the range of reserved Pas in Radio Access Network (RAN) sharing scenarios. Note that broadcasting of a range of reserved Pas for closed access cells is specified in 3GPP 36.331 and 3GPP 25.331.

Namely, each Public Land Mobile Network (PLMN), belonging to a certain RAN, might have its own set of reserved Pas for closed access cells, but the UE is only informed about the range of reserved Pas in the serving PLMN. If a UE encounters a target cell that is accessible in a PLMN different from the serving PLMN, then the UE will not know if there is a range of reserved Pas for closed access cells in that target PLMN. Hence, it is not possible for the UE to determine if PCI reuse between macro and other cell types occurs.

### SUMMARY

An object is alleviate, or at least reduce, some of the above mentioned problems and/or disadvantages.

According to a first aspect, the object is achieved by a method, performed by a wireless device connected to or camping on a first cell, for managing a measurement of a strength of a reference signal. The first cell is operated by a radio network node. The wireless device receives, from the radio network node, an indication relating to a property associated with an identity of a second cell neighbouring to the first cell. Moreover, the wireless device receives the identity of the second cell. Furthermore, the wireless device measures the strength of the reference signal identified by the identity of the second cell, only when the property indicates that the wireless device is to perform the measurement on the reference signal.

According to a second aspect, the object is achieved by a wireless device connected to or camping on a first cell, configured to manage a measurement of a strength of a reference signal. The first cell is configured to be operated by a radio network node. The wireless device is configured to receive an identity of a second cell neighbouring to the first cell; and to receive, from the radio network node, an indication relating to a property associated with the identity of the second cell. Furthermore, the wireless device is configured to measure the strength of the reference signal identified by the identity of the second cell, only when the property indicates that the wireless device is to perform the measurement on the reference signal.

According to a third aspect, the object is achieved by a method, performed by a radio network node, for enabling a wireless device to manage a measurement of a strength of a reference signal. A first cell is operated by the radio network node. The radio network node sends, to the wireless device connected to or camping on the first cell, an indication relating to a property associated with an identity of a second cell neighbouring to the first cell, whereby the wireless device performs the measurement only when the property indicates that the wireless device is to perform the measurement of the strength of the reference signal identified by the identity of the second cell.

According to a fourth aspect, the object is achieved by a radio network node, configured to enable a wireless device to manage a measurement of a strength of a reference signal. A first cell is configured to be operated by the radio network node. The radio network node is configured to send, to the wireless device connected to or camping on the first cell, an indication relating to a property associated with an identity of a second cell neighbouring to the first cell.

According to further aspects, the object is achieved by computer programs and computer program products corresponding to the aspects above.

Thus, according to the embodiments herein, undue measuring of the strength of the reference signal is prevented thanks to that the measuring is performed only when indicated by the property, e.g. as indicated by the indication relating to the property. Consequently, unnecessary processing in the wireless device as well as in the radio network node is avoided. As a result, the above mentioned object is achieved.

According to some first embodiments herein, the property relates to accessibility of the second cell. Then, the measuring of the strength of the reference signal is performed only when the property indicates that the second cell is accessible by the wireless device. As an example, the second cell is accessible when the second cell is a so called macro cell, when the second cell is a CSG cell with which the wireless device has a membership or the like. Hence, any other CSG cells, with which the wireless device does not have a membership, may not be measured by the wireless device.

According to some second embodiments, the property relates to a size of the second cell. Then, the measuring of the strength of the reference signal is performed only when the size of the second cell is smaller than a threshold value for size of cell and when the wireless device is in a high mobility state. Hence, for any second cell of small size, the wireless device does not perform any measurement when the wireless device is in high mobility state, since such any second cell of small size would anyway most probably be left, shortly after access is made or attempted, by the wireless device due to its high mobility state.

Advantageously, less radio measurements, such as the measuring of the strength of the reference signal, are performed according to embodiments herein. Thus, power and processing consumption in the wireless device is reduced.

Moreover, the radio network node is relieved from processing of measurement reports from the wireless device, since the wireless device performs and sends measurements reports only when indicated by the indication relating to the property of the second cell.

As a consequence of above, embodiments herein may accelerate procedures, performed by the wireless device and the radio network node, relating to measurements, processing and signalling exchange there between in connection with handover and/or cell reselection.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic overview of an exemplifying wireless communication system in which embodiments herein may be implemented,

FIG. 2 is a schematic, combined signalling scheme and flowchart illustrating embodiments of the methods when performed in the wireless communication system according to FIG. 1,

FIG. 3 is a flowchart illustrating the first embodiments,

FIG. 4 is a flowchart illustrating the second embodiments,

FIG. 5 is a flowchart illustrating embodiments of the method in the wireless device,

FIG. 6 is a block diagram illustrating embodiments of the wireless device,

FIG. 7 is a flowchart illustrating embodiments of the method in the radio network node, and

FIG. 8 is a block diagram illustrating embodiments of the radio network node.

### DETAILED DESCRIPTION

Throughout the following description similar reference numerals have been used to denote similar elements, units, modules, circuits, nodes, parts, items or features, when applicable. In the Figures, features that appear in some embodiments are indicated by dashed lines.

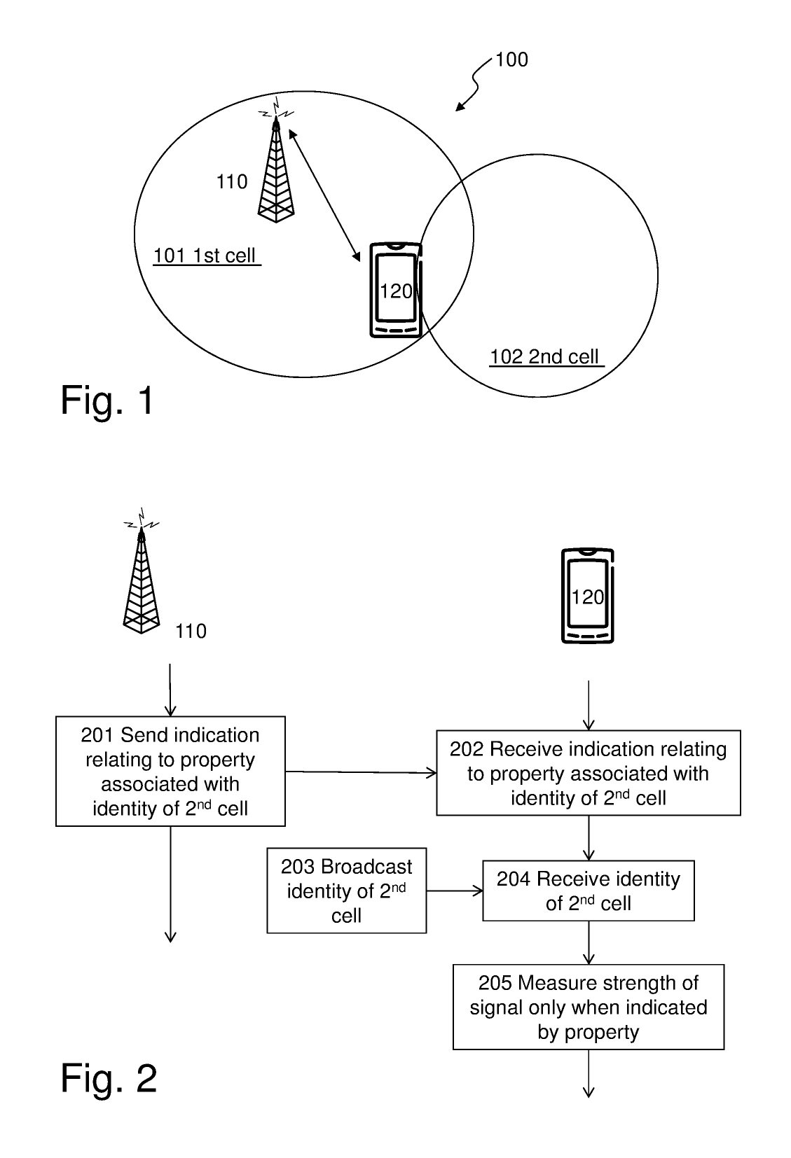

FIG. 1 depicts an exemplifying wireless communications system 100 in which embodiments herein may be implemented. In this example, the wireless communications system 100 is an LTE system. In other examples, the wireless communication system may be any 3GPP wireless communication system, such as a Universal Mobile Telecommunication System (UMTS), Wideband Code Division Multiple Access (WCDMA) network, a Global System for Mobile communication (GSM) or the like. The wireless communication system 100 may even be an evolution of any one of the aforementioned systems or a combination thereof.

The wireless communication system 100 comprises a radio network node 110. As used herein, the term “radio network node” may refer to a Base Station (BS), a Base Transceiver Station (BTS), a Radio Base Station (RBS), Remote Radio Unit (RRU), an access point, a NodeB in so called Third Generation (3G) networks, evolved Node B, eNodeB or eNB in Long Term Evolution (LTE) networks, or the like. In UMTS Terrestrial Radio Access Network (UTRAN) networks, the term “radio network node” may also refer to a Radio Network Controller. Furthermore, in Global System for Mobile Communications (GSM) EDGE Radio Access Network (GERAN), where EDGE is short for Enhanced Data rates for GSM Evolution, the term “radio network node” may also refer to a Base Station Controller (BSC).

The radio network node 110 may operate a first cell 101, such as a macro cell, a micro cell, a pico cell, a femto cell etc.

Furthermore, a wireless device 120 is located in the first cell 101. Expressed differently, the wireless device 120 may be associated with the first cell 101. This means that the wireless device 120 may be connected to, or served by the first cell 101, or the wireless device 120 may camp on the first cell 101.

As used herein, the term “wireless device” may refer to a user equipment, a subscriber unit, mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be any kind of weather sensor, such as wind, temperature, air pressure, humidity etc. As further examples, the sensor may be a light sensor, an electronic switch, a microphone, a loudspeaker, a camera sensor etc. Sometimes, the term “user”, or “subscriber”, may be used to refer to the wireless device.

Furthermore, the wireless communication system 100 comprises a second cell 102. The second cell 102 may be operated by the radio network node 110 or by a further radio network node (not shown). The second cell 102 is neighbouring to the first cell 101.

The radio network node 110 may manage a Neighbour Relation Table (NRT) or the like. The NRT may include an identity of the second cell 102. This means that the first and second cells 101, 102 are so called neighbouring cells.

As an example relating to LTE, the radio network node 110 hosts a so called Automatic Neighbour Relation (ANR) function. The ANR function builds and manages the NRT, which describes cells operated by the radio network node or cells located close to these cells, i.e. neighbouring cells. Various properties of the cells may be included in the NRT. For example, frequency, ECGI, size etc.

FIG. 2 illustrates an exemplifying method according to embodiments herein when implemented in the wireless communication system 100 of FIG. 1. Thus, the wireless device 120 performs a method for managing a measurement of a strength of a reference signal identified by an identity of the second cell 102 neighbouring to the first cell 101. Also, this means that the radio network node 110 performs a method for enabling the wireless device 120 to manage a measurement of the strength of the reference signal.

As mentioned, the wireless device 120 is connected to or camps on the first cell 101. The first cell 101 is operated by the radio network node 110

The following actions may be performed in any suitable order.

Action 201

In order to make the wireless device 120 aware of a property associated with the identity of the second cell 102, the radio network node 110 sends, to the wireless device 120 connected to or camping on the first cell 101, an indication relating to a property associated with the identity of the second cell 102, whereby the wireless device 120 performs the measurement only when the property indicates that the wireless device 120 is to perform the measurement of the strength of the reference signal.

The indication relating to the property may be sent to the radio network node 110 via broadcast signalling or dedicated signalling. For example, system information blocks, such as SIB4 to SIB8, may be used for broadcast signalling and rrcConnectionReconfiguration message may be used for dedicated signalling. The property may relate to possible outcome, e.g. long term and/or short term, of a handover or a reselection towards the second cell 102.

For example in connection with the first embodiments, the radio network may also send the CSG identity, or CSG ID, of the second cell 102 using dedicated or broadcast signalling as mentioned above.

The identity of the second cell 102 may comprise a Physical Cell Identity (PCI), a Location Area Code (LAC) or the like.

Action 202

When action 201 has been performed, the wireless device 120 receives the indication from the radio network node 110. Now that the indication has been received by the wireless device 120, the wireless device may as in action 205 take advantage thereof such as to prevent unnecessary measurements, measurement reports and/or the like. As an example, the wireless device 120 may receive a list of indications relating to properties for each PCI of a set of neighbouring cells. This means that each indication of the list may be associated with a respective PCI corresponding to a respective neighbouring cell of the set of neighbouring cells. The set of neighbouring cells may include the second cell 102. As an example, a portion of the above mentioned NRT may be sent to the wireless device 120.

Also in connection with the first embodiments, the property may indicate that the second cell 102 is a macro cell, a micro cell, an open CSG cell or a hybrid CSG cell or the like. A hybrid CSG cell refers to a CSG cell to which access is granted for both CSG members and non-members, where e.g. members may be prioritized, e.g. in terms of granted bit rate, number of members vs. non-members, etc, over non-members.

Action 203

The identity of the second cell 102 is broadcast. In some examples, when the second cell 102 is operated by the radio network node 110, the radio network node 110 broadcasts the identity of the second cell 102, e.g. in the form of a Primary Synchronization Signals (PSS) and a Secondary Synchronization Signals (SSS). In other examples, the further radio network node, not shown as mentioned above, may broadcast the identity of the second cell 102 in the same manner using a PSS and a SSS.

Action 204

Hence, e.g. by reading the PSS and SSS, the wireless device 120 receives the identity of the second cell 102. This means that the identity of the second cell 102 may be received by reading one or more synchronization signals.

Action 205

Thanks to that action 202 has been performed, the wireless device 120 is able to measure the strength of the reference signal identified by the identity of the second cell 102, only when the property or the CSG identity (if sent in 201) indicates that the wireless device 120 is to perform the measurement on the reference signal.

The measurement of the strength of the reference signal may comprise measuring one or more of RSRP (Reference Signal Received Power), Received Signal Strength Indicator (RSSI), RSRQ (Reference Signal Received Quality), Received Signal Code Power (RSCP) CPICH-Ec/No (Common Pilot Channel in UMTS and some other CDMA communications systems, Ec energy per chip over No —the total received power density excluding CPICH of own cell) of the reference signal. Expressed differently, the measuring is a measurement on the identity of the second cell 102, e.g. a PCI measurement.

In this manner, a number of physical layer measurements, such as the measurement of the strength of the reference signal, on cells, e.g. the second cell 102, in connection with handover and/or cell reselection is reduced.

Moreover, since no measurement is performed there will be no measurement report to the radio network node 110. Thus, the radio network node 110 will not send a Radio Resource Control (RRC) configuration message. As a result, processing and signalling in the radio network node 110 is reduced.

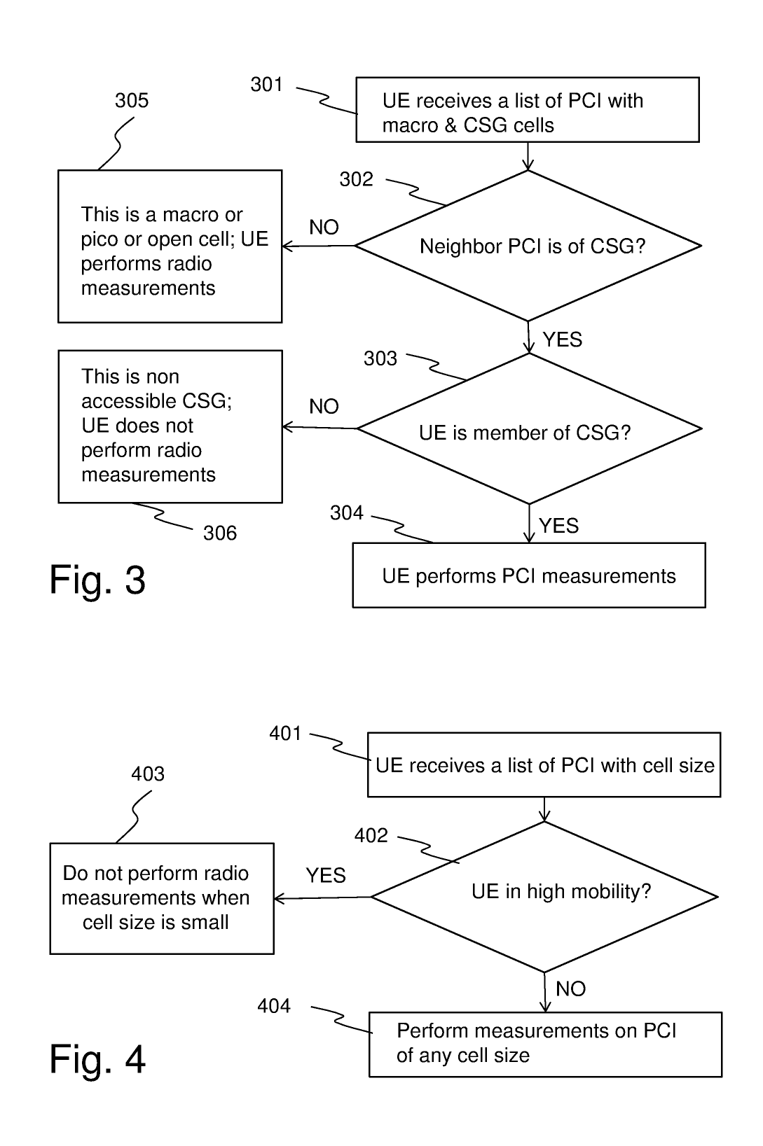

In some examples, this action may be preceded by an action of analysing, or checking, whether the property indicates that the measurement shall be performed. The analysis may be performed in different manners for the first and second embodiments as is described below and also with reference to FIGS. 3 and 4.

According to the first embodiments, the property may relate to accessibility of the second cell 102. Then, the wireless device 120 may perform the measurement of the strength of the reference signal only when the property indicates that the second cell 102 is accessible by the wireless device 120.

In some examples of the first embodiments, the wireless device 120 may also receive a CSG identity of the second cell 102 as indicated above.

See also FIG. 3.

According to the second embodiments, the property may relate to a size of the second cell 102. Then, the wireless device 120 may performs the measurement of the strength of the reference signal only when the size of the second cell 102 is greater than a threshold value for size of cell and when the wireless device 120 is in a high mobility state. See also FIG. 4.

As a first example, the high mobility state may be determined by detecting a number of cell reselections of the wireless device 120 e.g. according to 3GPP TS 36.304. Then, the wireless device 120 is in the high mobility state when the number of cell reselections exceeds a threshold value for cell reselections, also e.g. as in 3GPP TS 36.304.

As a second example, the high mobility state may be that the wireless device 120 is in the high mobility state when a speed of the wireless device 120 is above a threshold value for setting the high mobility state. The speed of the wireless device 120 may be obtained from a Global Position System, GPS, unit of the wireless device 120 or by monitoring cells on which the wireless device 120 camps or connects in time.

The wireless device 120 may now again return to action 202 or to action 204 to repeatedly, e.g. at a regular or irregular time intervals, perform one or more of the actions described above.

FIG. 3 is an exemplifying flow chart of the method according to the first embodiments. The wireless device 120, denoted UE in FIG. 3, may be connected to or camping on the radio network node 110. In this example, the identity of the second cell 102 is referred to as a PCI. Additionally, the second cell 102 is exemplified by a neighbouring cell. Moreover, the property is in this example a type of the neighbouring cell identified by the PCI. The type may indicate that the cell is a macro cell, a hybrid CSG cell or a closed CSG cell or the like.

Initially, when the wireless device 120 registers to one CSG HeNB, the operator would provide the SIM card of that wireless device 120 with some information about that HeNB, e.g. a CSG identity of the HeNB cell. In general, the wireless device 120 will be provisioned with a list of PCIs, CGIs and CSG IDs for all the accessible closed CSGs and for those Hybrid cells where the wireless device 120 is a member. Such information would be on white-list of the wireless device 120. According to some embodiments herein, the wireless device 120 may need to know the PCI of the cells where the wireless device 120 has access right or where the wireless device 120 is member. Such information could be transferred to the wireless device 120 in different ways e.g. via SIM card during HeNB deployment, together with CSG identity during broadcast or dedicated signalling.

In the first embodiments the wireless device 120 receives some additional information, e.g. CSG type (open, hybrid or closed) with/without CSG identity, of each PCI in its neighbourhood from the radio network node 110. Then, for each PCI the wireless device 120 reads the additional information, and if it is a CSG other than its own cell, the wireless device 120 will not make any measurement on that cell, e.g. the second cell 102. Otherwise, the wireless device 120 makes measurements on that cell.

In more detail, the following actions may be performed in any suitable order.

Action 301

The wireless device 120 receives a list of Pas with associated types of each respective PCI. In this manner, the wireless device is informed about which type the neighbouring cells have.

As an example, the list and associated type of cell may be received via one Information Elements (IE) of a System Information Block (SIB). In particular, SIB4 up to SIB8 may be used depending on the wireless communication system, e.g. LTE or Inter Radio Access Technology, holding the neighbour cell. Based on specification 3GPP 36.331, SIB4 is used for intra-frequency neighbours, SIB5 for inter-frequency neighbours, SIB6 for inter-RAT UMTS neighbours, SIB7 for inter-RAT GSM neighbours and SIB8 for inter-RAT CDMA neighbours.

As an example, for intra-frequency neighbour cells, type of cell (open, CSG, hybrid), cell size, and/or CSG identity may be sent together with PCI in the ‘IntraFreqNeighbCellList’ IE of SIB4.

Another way of forwarding is via dedicated signalling, such as via a rrcConnectionReconfguration message.

This action is similar to action 202.

Action 302

When the wireless device 120 e.g. moves, or when radio conditions change, the wireless device 120 may detect, or receive, a PCI of a neighbouring cell. Then, the wireless device 120 checks if the detected PCI is associated with the type indicating a closed CSG cell.

Action 303

This action is performed when the checking in action 302 confirms that the type indicates that the neighbour cell is a closed CSG cell. That is to say, “YES, the detected PCI is associated to a cell that is a closed CSG cell, or a hybrid CSG cell”.

Then, in this action, the wireless device 120 further checks if the wireless device 120 is a member of the CSG cell.

When the wireless device 120 receives the list of PCI together with the CSG type, then the wireless device 120 would know the CSG cell that it has membership to based on one or more of:
reading the CSG ID if present with the broadcasted PCI and CSG type; and
via proximity detection.

Reading the CSG identity refers to that the wireless device 120 in action 301 also receives any existing CSG identities for each PCI in the list. In order to determine whether the wireless device 120 is a member of the CSG cell, the wireless device 120 may compare one of said any existing CSG identities of the detected PCI to the initially provided CSG identity, e.g. by reading the SIM card or the like.

According to some embodiments herein, there is provided manners of informing the wireless device 120 about whether the PCI of a neighbour cell is belongs to a CSG group which the wireless device 120 is a member of. One exemplifying manner is to send to the wireless device 120, in addition to the PCI and the CSG type of the neighbours, the CSG Identity of each PCI on that neighbour list.

Proximity detection refers to detection of that the wireless device 120 is in the vicinity of a CSG cell with which it has a membership. Proximity detection is done in order to allow the wireless device 120 to know its proximity to it's CSG HeNB that it has membership to. This detection is usually done when the wireless device 120 detects what is called HeNB fingerprint which could be a sort of a list of neighbour PCI and relative signal strengths detected when in proximity of the accessible closed or hybrid CSG cells. Another way of detecting HeNB proximity would be using a GPS (Global Positioning System) of the wireless device 120 and comparing GPS location with the HeNB geographical location.

Action 304

This action is performed when the checking in action 303 confirms that the wireless device 120 is a member of the CSG cell. That is to say, “YES, the UE is a member of the CSG cell”.

Therefore, the wireless device 120 then performs the PCI measurement(s).

This action is similar to at least parts of action 205.

Action 305

In case action 302 results in the negative, i.e. the detected PCI is not associated to a CSG cell, then the wireless device 120 performs the PCI measurement(s).

Action 306

In case action 303 results in the negative, i.e. the wireless device 120 is not a member of the associated CSG cell, then the wireless device 120 does not perform the PCI measurement(s).

As a summary of the first embodiments, the following may apply:
If a CSG cell is identified and the PCI is not associated with a CSG the wireless device 120 has membership to then the wireless device 120 will not perform radio measurement of that cell.
If a PCI corresponds to a macro cell then the wireless device 120 performs measurement on the cell identified by that PCI
If the PCI belongs to a cell that is a closed or hybrid CSG and for which the wireless device 120 is member then the wireless device 120 performs radio measurements on the cell identified by the PCI as this might lead to a handover towards its own CSG cell.

Notably, in US20130109380, an enhanced NRT (Neighbor Relation Table) is built where in addition to the cell identity of each PCI, the information whether the cell is a CSG cell or not is included, amongst other additional information. The enhanced NRT is built via several means e.g. by using eNB Automatic Neighbour Relation (ANR) functionality where the wireless device 120 is asked via RRC dedicated message, rrconnectionreconfiguration, to report the ECGI of the reported PCI or by using OSS database where all information of each cell of the network are stored.

According to some embodiments herein, some information of such enhanced NRT is forwarded to the wireless device 120. In particular, with each PCI communicated to the wireless device 120, the cell type whether it is a macro or CSG type (open, hybrid or closed) represented by that PCI, is transmitted to the wireless device 120 as e.g. in action 201 and 203.

FIG. 4 is an exemplifying flow chart of the method according to the second embodiments. Again, the wireless device 120, denoted UE in FIG. 4, may be connected to or camping on the radio network node 110. In this example, the identity of the second cell 102 is referred to as a PCI. Additionally, the second cell 102 is exemplified by a neighbouring cell. Moreover, the property is in this example a size of the neighbouring cell identified by the PCI. The size may for example be indicated as small, medium, large, very large or the like.

Action 401

The wireless device 120 receives a list of Pas with an associated respective cell size for each PCI in the list. In this manner, the wireless device is informed about sizes of the neighbouring cells.

The cell size, or the size of the cell, may follow a format adopted in TS36.423v11.5.0, where cell size is expressed by an information element (IE) as shown below:

| IE/Group | | | IE type and | Semantics | | Assigned |
|---|---|---|---|---|---|---|
| Name | Presence | Range | reference | description | Criticality | Criticality |
| Cell Size | M | | ENUMERATED | | — | — |
| | | | (verysmall, small, | | | |
| | | | medium, large, . . . ) | | | |

This action is similar to action 202.

Action 402

In order to take advantage of the information provided in action 401, the wireless device 120 checks whether it is in a so called high mobility state.

As an example, the high mobility state may be defined as in 3GPP TS 36.304 “LTE; EUTRA; UE procedures in idle mode”, in which the wireless device 120 is stated to be in high mobility if number of cell reselection during a period of time exceeds a certain threshold.

Action 403

If action 402 indicates that the wireless device 120 is in high mobility, then the wireless device 120 does not perform the PCI measurement(s) if the cell size is small.

Action 404

In contrast to action 403, the wireless device 120 performs the PCI measurement(s) irrespectively of cell size since the wireless device is not in the nigh mobility state.

At this point, in further embodiments, the first embodiment may be applied in order to prevent the wireless device 120 to perform the PCI measurement(s) on e.g. CSG cell with which it has no membership as is explained above in relation to FIG. 3. Hence, in these further embodiments, the wireless device is aware of the indication relating to a property associated with the identity of the neighbouring cell, wherein the property relates to a type of the neighbouring cell as well as a size of the neighbouring cell.

Notably, in US20130084870, the network, in particular the eNB handles the handover based on target cell size. According to this document, handover prevention is achieved by that the eNB does not handover the UE to a cell with a small size. In order to that both the UE and the eNB have to perform a certain number of actions before the handover is prevented towards the cell with a small size. In more detail, the UE sends measurements reports about neighbour cells and the eNB selects target cell for handover based on target cell size and on UE speed.

Advantageously, according to at least the second embodiments, the wireless device 120 as well as the radio network node 110 may performs fewer actions than the certain number of actions required according to US20130084870, while at the same time avoiding handover to a cell with a small size when the wireless device 120 is in the high mobility state. As mentioned, this is realized according to at least some embodiments herein by transferring to the wireless device, the identity of and size of each neighbour cell.

Considering the second embodiments relating to the radio network node 110, the case in which the size of the neighbouring cell is sent via broadcast signalling is hereby disclaimed as not being part of the embodiments herein.

As a summary of the second embodiments, when the wireless device 120 is in high mobility state, for each PCI the wireless device 120 looks at the cell size then:

If the cell represented by that PCI is of a small size it does not perform measurements on it;

Otherwise the wireless device 120 performs the PCI measurement.

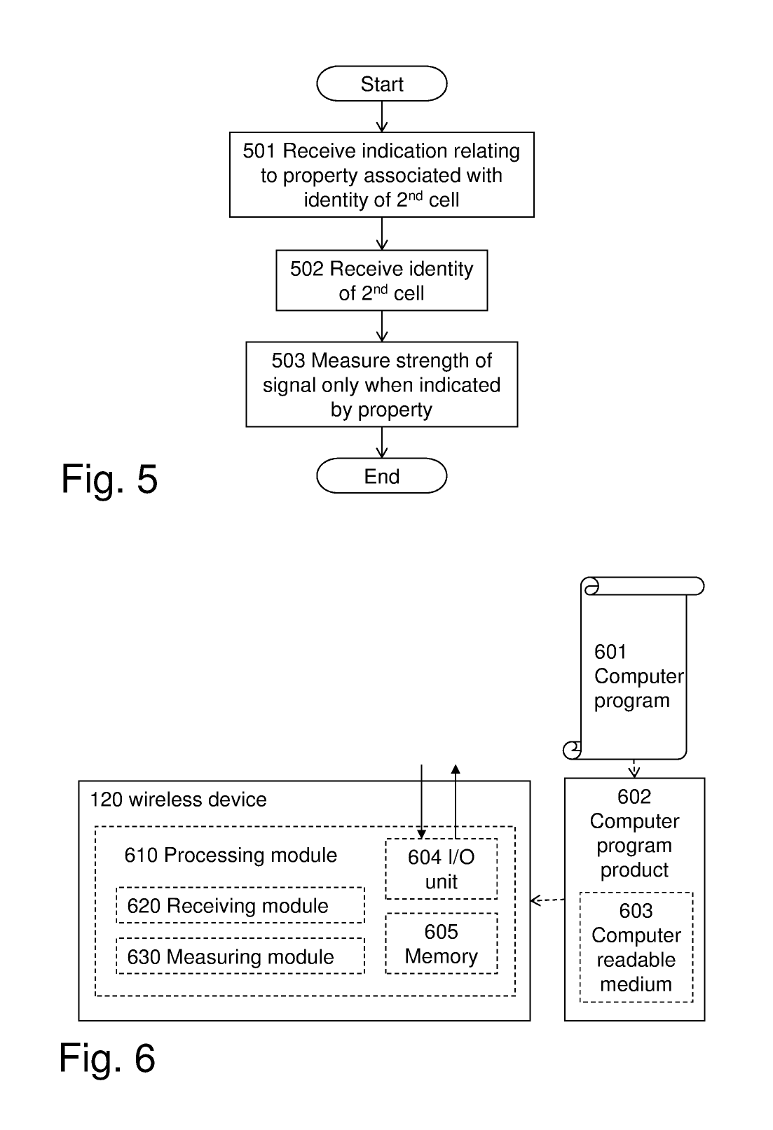

In FIG. 5, an exemplifying, schematic flowchart of the method in the wireless device 120 is shown. As mentioned, the wireless device 120, being connected to or camping on the first cell 101, performs a method for managing a measurement of a strength of a reference signal identified by an identity of the second cell 102 neighbouring to the first cell 101.

As mentioned, the first cell 101 is operated by the radio network node 110. The identity of the second cell 102 may be received by reading one or more synchronization signals. The identity of the second cell 102 may comprise a Physical Cell Identity, a Location Area Code or the like.

The following actions may be performed in any suitable order.

Action 501

The wireless device 120 receives receiving 202, from the radio network node 110, an indication relating to a property associated with the identity of the second cell 102.

As mentioned, the indication relating to the property may be received via broadcast signalling or dedicated signalling.

This action is similar to action 202.

Action 502

The wireless device 120 receives 204 the identity of the second cell 102. This action is similar to action 204.

Action 503

The wireless device 120 measures, e.g. performs a measurement of, the strength of the reference signal identified by the identity of the second cell 102, only when the property indicates that the wireless device 120 is to perform the measurement on the reference signal. The measurement of the strength of the reference signal may comprise measuring one or more of RSRP, RSRQ, RSSI, RSCP, CPICH-Ec/No of the reference signal.

As mentioned according to the first embodiments, the property may relate to accessibility of the second cell 102. Then, the wireless device 120 may perform the measurement of the strength of the reference signal only when the property indicates that the second cell 102 is accessible by the wireless device 120. In some examples of the first embodiments, the wireless device 120 may receive a CSG identity of the second cell 102.

As mentioned according to the second embodiments, the property may relate to a size of the second cell 102. Then, the wireless device 120 may performs the measurement of the strength of the reference signal only when the size of the second cell 102 is greater than a threshold value for size of cell and when the wireless device 120 is in a high mobility state.

This action is similar to action 205.

With reference to FIG. 6, a schematic block diagram of the wireless device 120 is shown. The wireless device 120 is configured to perform the methods in FIGS. 2, 3, 4 and/or 5. Thus, the wireless device 120, being connected to or camping on the first cell 101, is configured to manage a measurement of a strength of a reference signal identified by an identity of a second cell 102 neighbouring to the first cell 101.

As mentioned, the first cell 101 is operated by the radio network node 110.

According to some embodiments herein, the wireless device 120 may comprise a processing module 610. In further embodiments, the processing module 610 may comprise one or more of a receiving module 620 and a measuring module 630.

The wireless device 120, the processing module 610 and/or the receiving module 620 is configured to receive the identity of the second cell 102.

Furthermore, the wireless device 120, the processing module 610 and/or the receiving module 620 is configured to receive, from the radio network node 110, an indication relating to a property associated with the identity of the second cell 102.

The wireless device 120, the processing module 610 and/or the measuring module 630 is configured to measure the strength of the reference signal identified by the identity of the second cell 102, only when the property indicates that the wireless device 110 is to perform the measurement on the reference signal.

According to the first embodiments, the property may relate to accessibility of the second cell 102, wherein the wireless device 120 is configured to perform the measuring of the strength of the reference signal only when the property indicates that the second cell 102 is accessible by the wireless device 120.

In some examples of the first embodiments, the wireless device 120 may be configured to receive a CSG identity of the second cell 102.

According to the second embodiments, the property may relate to a size of the second cell 102, wherein the wireless device 120 is configured to measure the strength of the reference signal only when the size of the second cell 102 is greater than a threshold value for size of cell and when the wireless device 120 is in a high mobility state.

Further, the indication relating to the property of the second cell 102 may be received via broadcast signalling or dedicated signalling.

Again, the identity of the second cell 102 may comprise a Physical Cell Identity, a Location Area Code or the like.

The identity of the second cell 102 may be received by reading one or more synchronization signals.

The wireless device 120 may be configured to measure the strength of the reference signal in terms of one or more of RSRP, RSRQ, RSSI, RSCP, CPICH-Ec/No of the reference signal.

The wireless device 120 may further comprise an Input/output (I/O) unit 604 configured to send and/or receive the indication relating to the property associated with the identity of the second cell 102 and/or other messages, indications and the like as described herein. The I/O unit 604 may comprise the receiving module 620, a transmitter and/or a receiver.

Furthermore, the wireless device 120 may comprise a memory 605 for storing software to be executed by, for example, the processing module when the processing module is implemented as a hardware module comprising at least one processor or the like.

FIG. 6 also illustrates software in the form of a computer program 601, comprising computer readable code units which when executed on the wireless device 120 causes the wireless device 120 to perform the method according to FIGS. 2, 3, 4 and/or 5.

Finally, FIG. 6 illustrates a computer program product 602, comprising computer readable medium 603 and the computer program 601 as described directly above stored on the computer readable medium 603.

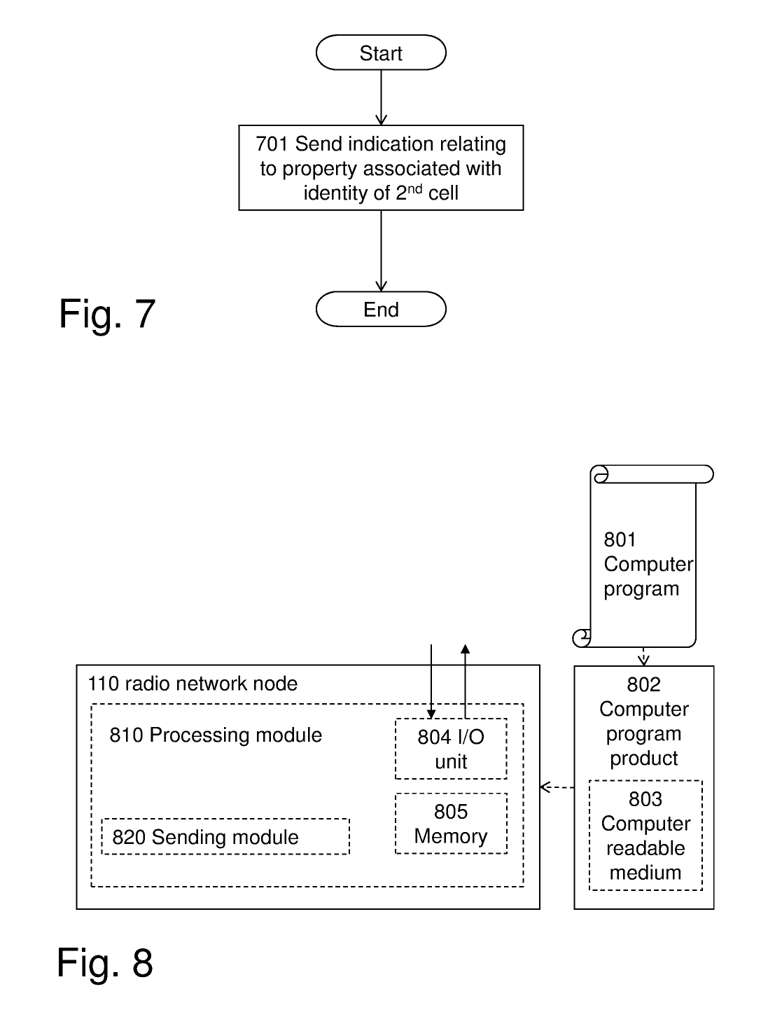

In FIG. 7, an exemplifying, schematic flowchart of the method in the radio network node 110 is shown. As mentioned, the radio network node 110 performs a method for enabling the wireless device 120 to manage a measurement of a strength of a reference signal identified by an identity of the second cell 102 neighbouring to the first cell 101.

As mentioned, the first cell 101 is operated by the radio network node 110.

The following actions may be performed in any suitable order.

Action 701

The radio network node 110 sends, to the wireless device 120 located in the first cell 101, an indication relating to a property associated with the identity of the second cell 102, whereby the wireless device 120 performs the measurement only when the property indicates that the wireless device 120 is to perform the measurement of the strength of the reference signal.

As mentioned, the indication relating to the property of the second cell 102 may be sent via broadcast signalling or dedicated signalling. The identity of the second cell 102 may comprise a Physical Cell Identity, a Location Area Code or the like.

According to the first embodiments, the property may relate to accessibility of the second cell 102, whereby the measurement of the strength of the reference signal is performed only when the property indicates that the second cell 102 is accessible by the wireless device 120.

In some examples of the first embodiments, the radio network node 110 may send a CSG identity of the second cell 102,

According to the second embodiments, the property may relate to a size of the second cell 102, whereby the measurement of the strength of the reference signal is performed only when the size of the second cell 102 is greater than a threshold value for size of cell and when the wireless device 120 is in a high mobility state.

This action is similar to action 201.

With reference to FIG. 8, a schematic block diagram of the radio network node 110 is shown. The radio network node 110 is configured to perform the methods in FIGS. 2, 3, 4 and/or 7. Thus, the radio network node 110 is configured to enable a wireless device 120 to manage a measurement of a strength of a reference signal identified by an identity of a second cell 102.

As mentioned, the first cell 101 is operated by the radio network node 110.

According to some embodiments herein, the radio network node 110 may comprise a processing module 810. In further embodiments, the processing module 810 may comprise a sending module 820.

The radio network node 110, the processing module 810 and/or the sending module 820 is configured to send, to the wireless device 120 located in the first cell 101, an indication relating to a property associated with the identity of the second cell 102.

As mentioned according to the first embodiments, the property may relate to accessibility of the second cell 102. In some examples of the first embodiments, the radio network node 110 may be configured to send a CSG identity of the second cell 102.

As mentioned according to the second embodiments, the property may relate to a size of the second cell 102.

Further, the indication relating to the property of the second cell 102 may be sent via broadcast signalling or dedicated signalling.

Again, the identity of the second cell 102 may comprise a Physical Cell Identity, a Location Area Code or the like.

The radio network node 110 may further comprise an Input/output (I/O) unit 804 configured to send and/or receive the indication relating to the property associated with the identity of the second cell 102 and/or other messages, indications and the like as described herein. The I/O unit 804 may comprise the sending module 820, a transmitter and/or a receiver.

Furthermore, the radio network node 110 may comprise a memory 805 for storing software to be executed by, for example, the processing module when the processing module is implemented as a hardware module comprising at least one processor or the like.

FIG. 8 also illustrates software in the form of a computer program 801, comprising computer readable code units which when executed on the radio network node 110 causes the radio network node 110 to perform the method according to FIGS. 2, 3, 4 and/or 7.

Finally, FIG. 8 illustrates a computer program product 802, comprising computer readable medium 803 and the computer program 801 as described directly above stored on the computer readable medium 803.

As used herein, the term “processing module” may refer to a processing circuit, a processing unit, a processor, an Application Specific integrated Circuit (ASIC), a Field-Programmable Gate Array (FPGA) or the like. As an example, a processor, an ASIC, an FPGA or the like may comprise one or more processor kernels. In some examples, the processing module may be embodied by a software module or hardware module. Any such module may be a determining means, estimating means, capturing means, associating means, comparing means, identification means, selecting means, receiving means, transmitting means or the like as disclosed herein. As an example, the expression “means” may be a module, such as a determining module, selecting module, etc.

As used herein, the expression “configured to” may mean that a processing circuit is configured to, or adapted to, by means of software configuration and/or hardware configuration, perform one or more of the actions described herein.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal

Serial Bus (USB) memory, a DVD-disc, a Blu-ray disc, a software module that is received as a stream of data, a Flash memory, a hard drive, a memory card, such as a MemoryStick, a Multimedia Card (MMC), etc.

As used herein, the term “computer readable code units” may be text of a computer program, parts of or an entire binary file representing a computer program in a compiled format or anything there between.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1-28. (canceled)

29. A method, performed by a wireless device connected to or camping on a first cell, for managing a measurement of a strength of a reference signal, wherein the first cell is operated by a radio network node, wherein the method comprises:
receiving, from the radio network node, an indication relating to a property associated with an identity of a second cell neighboring to the first cell;
receiving the identity of the second cell; and
only when the property indicates that the wireless device is to perform the measurement on the reference signal, measuring the strength of the reference signal identified by the identity of the second cell.

30. The method of claim 29, wherein the property relates to accessibility of the second cell, wherein the receiving of the indication further comprises receiving a Closed Subscriber Group (CSG) identity of the second cell, wherein the measuring of the strength of the reference signal is performed only when the property indicates that the second cell is accessible by the wireless device.

31. The method of claim 29, wherein the property relates to a size of the second cell, wherein the measuring of the strength of the reference signal is performed only when the size of the second cell is greater than a threshold value for size of cell and when the wireless device is in a high mobility state.

32. The method of claim 29, wherein the identity of the second cell is received by reading one or more synchronization signals.

33. The method of claim 29, wherein the indication relating to the property is received via broadcast signaling or dedicated signaling.

34. The method of claim 29, wherein the identity of the second cell comprises a Physical Cell Identity or a Location Area Code.

35. The method of claim 29, wherein the measuring of the strength of the reference signal comprises measuring one or more of RSRP, RSRQ, RSSI, RSCP, or CPICH-Ec/No, of the reference signal.

36. A method, performed by a radio network node, for enabling a wireless device to manage a measurement of a strength of a reference signal, wherein a first cell is operated by the radio network node, wherein the method comprises:
sending, to the wireless device connected to or camping on the first cell, an indication relating to a property associated with an identity of a second cell neighboring to the first cell, whereby the wireless device performs the measurement only when the property indicates that the wireless device is to perform the measurement of the strength of the reference signal identified by the identity of the second cell.

37. The method of claim 36, wherein the property relates to accessibility of the second cell, wherein the sending of the indication further comprises sending a Closed Subscriber Group (CSG) identity of the second cell, whereby the measurement of the strength of the reference signal is performed only when the property indicates that the second cell is accessible by the wireless device.

38. The method of claim 36, wherein the property relates to a size of the second cell, whereby the measurement of the strength of the reference signal is performed only when the size of the second cell is greater than a threshold value for size of cell and when the wireless device is in a high mobility state.

39. The method of claim 36, wherein the indication relating to the property of the second cell is sent via broadcast signaling or dedicated signaling.

40. The method of claim 36, wherein the identity of the second cell comprises a Physical Cell Identity or a Location Area Code.

41. A wireless device connected to or camping on a first cell, configured to manage a measurement of a strength of a reference signal, wherein the first cell is configured to be operated by a radio network node, wherein the wireless device is configured to:
receive an identity of a second cell neighboring to the first cell;
receive, from the radio network node, an indication relating to a property associated with the identity of the second cell; and
only when the property indicates that the wireless device is to perform the measurement on the reference signal, measure the strength of the reference signal identified by the identity of the second cell.

42. The wireless device of claim 41, wherein the property relates to accessibility of the second cell, wherein the wireless device further is configured to receive a Closed Subscriber Group (CSG) identity of the second cell, wherein the wireless device is configured to perform the measuring of the strength of the reference signal only when the property indicates that the second cell is accessible by the wireless device.

43. The wireless device of claim 41, wherein the property relates to a size of the second cell, wherein the wireless device is configured to measure the strength of the reference signal only when the size of the second cell is greater than a threshold value for size of cell and when the wireless device is in a high mobility state.

44. The wireless device of claim 41, wherein the identity of the second cell is received by reading one or more synchronization signals.

45. The wireless device of claim 41, wherein the indication relating to the property is received via broadcast signaling or dedicated signaling.

46. The wireless device of claim 41, wherein the identity of the second cell comprises a Physical Cell Identity or a Location Area Code.

47. The wireless device of claim 41, wherein the wireless device is configured to measure the strength of the reference signal in terms of one or more of RSRP, RSRQ, RSSI, RSCP, or CPICH-Ec/No, of the reference signal.

48. A radio network node, configured to enable a wireless device to manage a measurement of a strength of a reference signal, wherein a first cell configured to be operated by the radio network node, wherein the radio network node is configured to:
send, to the wireless device connected to or camping on the first cell, an indication relating to a property associated with an identity of a second cell neighboring to the first cell.

49. The radio network node of claim 48, wherein the property relates to accessibility of the second cell, wherein the radio network node is configured to send a Closed Subscriber Group (CSG) identity of the second cell.

50. The radio network node of claim 48, wherein the property relates to a size of the second cell.

51. The radio network node of claim 48, wherein the indication relating to the property of the second cell is sent via broadcast signaling or dedicated signaling.

52. The radio network node of claim 48, wherein the identity of the second cell comprises a Physical Cell Identity or a Location Area Code.
